(19) United States
(12) Patent Application Publication
(10) Pub. No.: US 2015/0089260 A1
(43) Pub. Date: Mar. 26, 2015

(54) Electronic Apparatus, Method, and Storage Medium

(71) Applicant: Kabushiki Kaisha Toshiba, Tokyo (JP)

(72) Inventor: Tomonori Tsutsui, Ome-shi (JP)

(21) Appl. No.: 14/330,886

(22) Filed: Jul. 14, 2014

(30) Foreign Application Priority Data
Sep. 26, 2013 (JP) 2013-199647

(51) Int. Cl. G06F 1/32; G06F 1/26

(52) U.S. Cl. CPC G06F 1/3212; G06F 1/263; G06F 1/324
USPC 713/322; 713/320

(57) ABSTRACT

According to one embodiment, an electronic apparatus includes a measurement module configured to measure power of a secondary battery, a comparator configured to compare the measured power with a first threshold and with a second threshold smaller than the first threshold, and a controller configured to, when the electronic apparatus is driven by the secondary battery, operate the electronic apparatus in any one of a first power range, second power range, and third power range based on the comparison. The first power range requires greater power than power required in the second power range, and the second power range requires greater power than power required in the third power range.

### CROSS-REFERENCE TO RELATED APPLICATIONS

This application is based upon and claims the benefit of priority from Japanese Patent Application No. 2013-199647, filed Sep. 26, 2013, the entire contents of which are incorporated herein by reference.

### FIELD

Embodiments described herein relate generally to an electronic apparatus, method, and storage medium configured to control a secondary battery.

### BACKGROUND

A conventional mobile electronic apparatus such as a notebook computer or a tablet computer includes a built-in battery pack which powers the apparatus when AC power is unavailable. As the secondary cells of the battery pack, lithium-ion cells, for example, are used. A property of a secondary cell is its continuous discharge rating when power is supplied to an electronic apparatus. The continuous discharge rating is the maximum continuous power attainable at any time during the period between full charge and full discharge under the condition that the temperature of no cell in the battery pack exceeds a predetermined upper limit. The continuous discharge rating of the battery pack is generally set to be greater than or equal to the power demandable by the electronic apparatus. However, in an apparatus designed to be lightweight and inexpensive, there may be a case where, depending on the operating status of, for example, the CPU, the power demanded by the electronic apparatus cannot be met without exceeding the rating. In that case, discharge may continue above the continuous discharge rating, overheating may occur, and consequently, the battery pack may fail.

If the power required for the electronic apparatus exceeds the rating of the secondary battery, the power consumption of the electronic apparatus is reduced by throttle control, which is one of the CPU functions, to lower the clock frequency thereof. However, lowering the clock frequency means compromising the performance of the electronic apparatus, and thus, it is not a user-friendly process.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 illustrates an example of a general system structure of an electronic apparatus of the present embodiment.

FIG. 2 shows an example of state transition of the present embodiment.

FIG. 3 shows an example of battery characteristics used for determination of a peak threshold in the present embodiment.

FIG. 4 shows an example of battery characteristics for throttle control of the present embodiment.

FIG. 5 is an exemplary flowchart illustrating an operation of an embedded controller of the present embodiment.

FIG. 6 is an exemplary flowchart illustrating details of a system load power check in the flowchart shown in FIG. 5.

FIG. 7 is an exemplary flowchart illustrating details of a cell temperature check in the flowchart shown in FIG. 5.

### DETAILED DESCRIPTION

Various embodiments will be described hereinafter with reference to the accompanying drawings.

In general, according to one embodiment, an electronic apparatus driven by a secondary battery, includes a measurement module configured to measure power of the secondary battery, a comparator configured to compare the power measured by the measurement module with a first threshold and with a second threshold smaller than the first threshold, and a controller configured to, when the electronic apparatus is driven by the secondary battery, operate the electronic apparatus in any one of a first power range, second power range, and third power range based on the comparison by the comparator. The first power range requires greater power than power required in the second power range, and the second power range requires greater power than power required in the third power range.

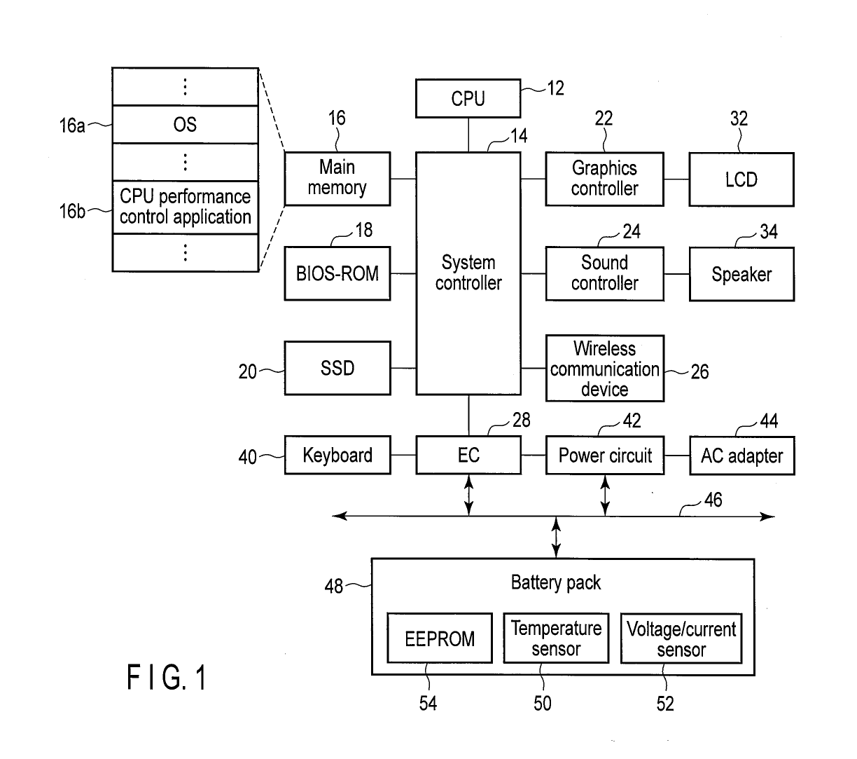

Hereinafter, a first embodiment is described with reference to the drawings. In this embodiment, it is assumed that the electronic apparatus is a notebook computer; however, the electronic apparatus is not limited thereto and may be, for example, a tablet computer or a portable game console. FIG. 1 illustrates a general system structure of such an electronic apparatus as a computer or portable game console. The computer includes a CPU 12, system controller 14, main memory 16, BIOS-ROM 18, solid-state drive (SSD) 20, graphics controller 22, sound controller 24, wireless communication device 26, and embedded controller (EC) 28.

The CPU 12 is a processor configured to control operation of each component in the computer. The CPU 12 includes a throttling function to reduce the operating frequency and so decrease power consumption. The CPU 12 executes various software programs loaded in the main memory 16 from the SSD 20 which is a nonvolatile storage device. The software programs include, for example, an operating system (OS) 16a and a CPU performance control application program 16b.

When the apparatus is powered by the battery, the CPU performance control application program 16b performs throttle control of the CPU corresponding to the load of system to reduce the load.

The CPU 12 executes a Basic Input/Output System (BIOS), which is a program for hardware control stored in the BIOS-ROM 18.

The system controller 14 is a device configured to connect the CPU 12 to various components. The system controller 14 includes a built-in memory controller (not shown) used for the access control of the main memory 16. The system controller 14 is connected to the main memory 16, BIOS-ROM 18, SSD 20, graphics controller 22, sound controller 24, wireless communication device 26, and embedded controller 28, etc.

The graphics controller 22 controls an LCD 32 used as a display monitor of a computer. The graphics controller 22 transmits a display signal to the LCD 32 under the control of the CPU 12. The LCD 32 displays a screen image based on the display signal.

The sound controller 24 is a controller configured to process an audio signal and control audio output from a speaker 34.

The wireless communication device 26 is a device configured to execute wireless communication such as wireless LAN communication and 3G mobile communication, or close-proximity wireless communication such as near-field communication (NFC).

The embedded controller 28 is a single-chip microcomputer including a controller for power management. The embedded controller 28 functions to turn the computer on or off in accordance with operation of the power button by the user. The embedded controller 28 is connected with a keyboard 40 and a power circuit 42. The power circuit 42 is connected to an AC adapter 44 whose attachment/detachment is detectable by the power circuit 42.

The embedded controller 28 and the power circuit 42 are connected to a battery pack 48 via a bus line 46. The battery pack 48 includes a temperature sensor 50, voltage/current sensor 52, and EEPROM 42. The battery pack 48 includes, for example, a lithium-ion battery. The EEPROM 42 stores battery data such as charge/discharge current, charge/discharge voltage, capacity, battery temperature, battery voltage, internal status. Charging of the battery pack 48 is performed in such a manner that the power circuit 42 supplies both charge voltage and charge current to the battery pack 48 when the embedded controller 28 sends a charge request designating both charge voltage value and charge current value to the power circuit 42.

The battery pack 48 supplies power to the computer. As described above, in the electronic apparatus designed to be lightweight and inexpensive, the power required for the electronic apparatus may not be supplied by the system load power of the battery pack 48 alone. For example, a battery pack 48 whose continuous discharge rating is 75 W may be installed in a computer whose load power is 180 W. The power 180 W is consumed when an AC adapter is used. If the load power of the electronic apparatus exceeds the continuous discharge rating of the battery pack 48, the battery pack 48 may fail because of overheating, etc. Thus, the embedded controller 28 monitors the system load power of the computer based on the system load power of the battery pack 48, compares the power with the rating, and controls the power circuit 42 and the CPU 12 on the basis of the comparison result. If the system load power of the computer exceeds the continuous discharge rating, the embedded controller 28 reduces the clock frequency of the CPU 12 by throttle control and adjusts the system load power of the computer within the continuous discharge rating.

In addition to the continuous discharge rating, the battery pack 48 of the present embodiment has its peak threshold. The peak threshold is greater than the continuous discharge rating. Even if the system load power of the computer exceeds the continuous discharge rating, a large amount of power consumed continuously is a rare case. In many cases, a large amount of power is demanded momentarily or for a short duration. Thus, the throttle control is also performed momentarily or for a short duration.

However, even such momentary or short-duration throttle control delays processing temporarily and so inconveniences the user. To address this problem, the present embodiment defines the peak threshold which is greater than the continuous discharge rating and provides different throttling frequencies used in the case where the system load power exceeds the continuous discharge rating and used in the case where the system load power exceeds the peak threshold. Using such two-step throttle control, the clock frequency of the CPU is decreased and the power consumption of the electronic apparatus is reduced in two steps. Thus, even if the system load power of the computer exceeds the continuous discharge rating, the throttling frequency does not decrease substantially or the processing speed does not decrease substantially.

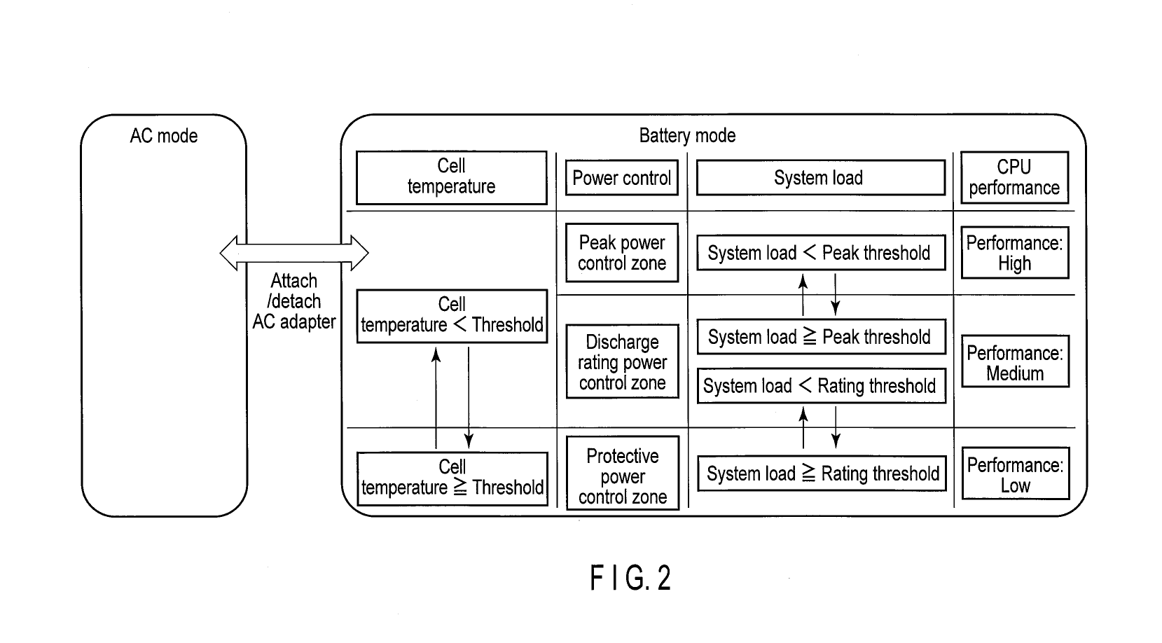

FIG. 2 illustrates a state transition diagram in the present embodiment. According to the attachment/detachment of the AC adapter 44, the computer switches between AC mode and battery mode. In AC mode, the computer functions under the system load power of 180 W, and the performance of the CPU is kept at its maximum, so that throttle control is not performed.

When the AC adapter is detached and the computer is in battery mode, the system load power of the computer (simply referred to as the “system load” in FIG. 2) may possibly exceed its peak threshold. Thus, a predetermined throttle control to decrease the clock frequency of the CPU by, for example, approximately 30% is performed so that the system load power of the computer is kept below the peak threshold. This throttle control is hereinafter referred to as a “peak” power control zone. When this power control is performed, the performance of the CPU is set to high.

Decreasing the clock frequency of the CPU is not the only way to reduce the system load. Decreasing the driving voltage of the CPU is also effective.

If the system load power exceeds the peak threshold while control is in the peak zone, further throttle control to decrease the clock frequency of the CPU by, for example, approximately 50% is performed. This throttle control is hereinafter referred to as a “discharge rating” power control zone. When this power control is performed, the performance of the CPU is set to medium. If the system load power is reduced to be less than the peak threshold while control is in the discharge rating zone, power control is transferred back to the peak zone by raising the clock frequency. Thus, the performance of the CPU is set to high again.

If the system load power exceeds the continuous rating threshold while power control is in the discharge rating zone, further throttle control to decrease the clock frequency of the CPU by, for example, approximately 80% is performed. This throttle control is hereinafter referred to as occupying a “protective” power control zone. When this power control is performed, the performance of the CPU is set to low. If the system load power is reduced to be less than the continuous rating threshold while power control is in the protective zone, power control is transferred back to the discharge rating zone by raising the throttle frequency. Thus, the performance of the CPU is set to medium again.

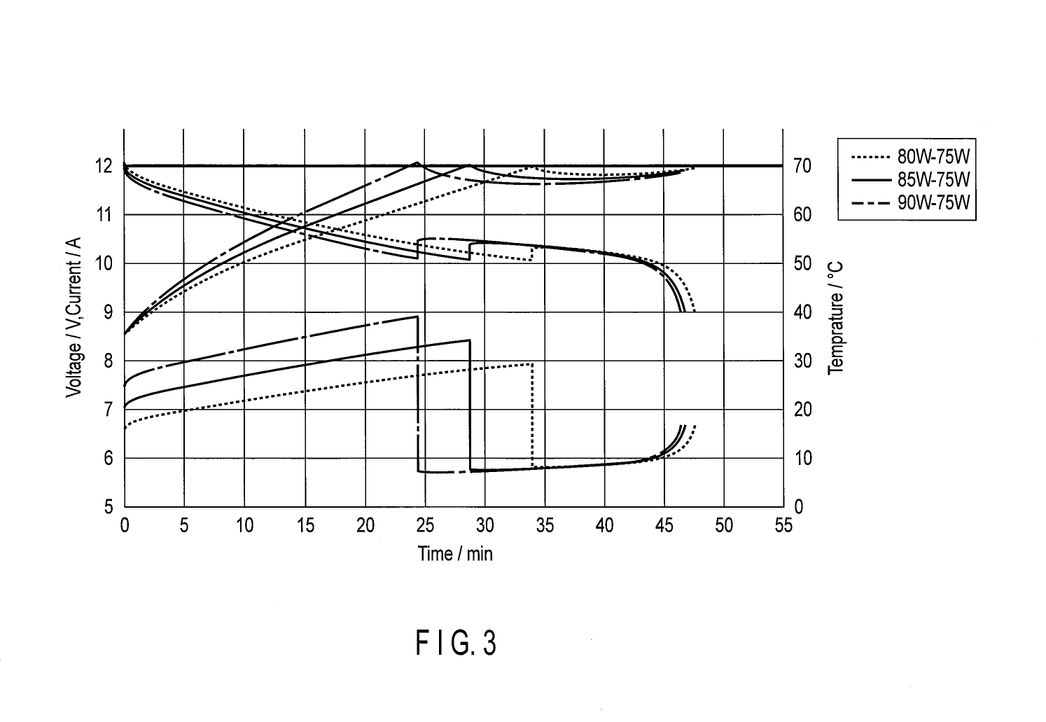

Now, the peak threshold is described with reference to FIG. 3. The continuous discharge rating is the maximum value of the power to be continuously discharged by the battery while the temperature of the battery is maintained within the heat limit. On the other hand, the peak threshold is used to determine what wattage the battery pack 48 can handle. The following values are used to define the peak threshold.
Continuous discharge rating: 75 W
Upper limit of cell temperature: 80° C.
Peak threshold: 80/85/90 W

The upper limit of the cell temperature is set to 80° C. as above. However, to allow some margin, if the cell temperature reaches 70° C., the discharge performance is reduced to check whether or not the battery pack 48 can be fully discharged without problem. The result of this check is illustrated in FIG. 3, which shows charge/discharge current, cell voltage, and cell temperature relative to the time lapse. In FIG. 3, the line of alternate long and short dashes indicates the case where the peak threshold is 90 W, the solid line indicates the case where the peak threshold is 85 W, and the dotted line indicates the case where the peak threshold is 80 W. As shown in FIG. 3, the cell voltage decreases with time whereas the charge/discharge current and cell temperature increase. As can be understood from FIG. 3, when the peak threshold is 80, 85, or 90 W, the discharge can be completed without problem. If the peak threshold is 100 W, the cell temperature may exceed 80° C. Therefore, the peak threshold is set to 90 W. At the 47- to 48-minute point on the time axis, the cell enters the complete discharge state.

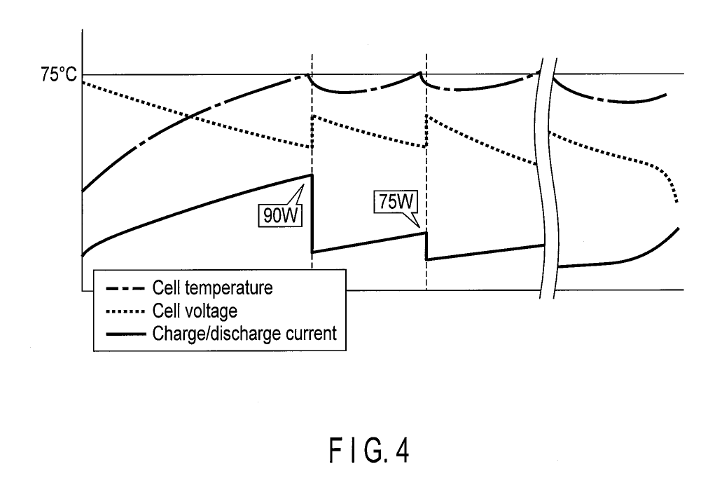

FIG. 4 shows how the cell voltage, charge/discharge current, and cell temperature change as a result of throttle control of the CPU. If the system load power reaches the peak threshold (90 W) in battery mode (when power control is in the peak zone, where the throttle frequency is lowered by approximately 30%), power control is transferred to the discharge rating zone, where the throttle frequency is lowered by approximately 50%. As a result, the cell voltage increases to a certain extent; however, the charge/discharge current decreases substantially and the cell temperature also decreases to a certain extent. The system load power decreases substantially and the continuous discharge rating becomes 75 W or less.

In this state, if the discharge is continued until the system load power increases to reach the continuous discharge rating (75 W), power control is transferred to the protective zone, where the throttle frequency is lowered by approximately 80%. The cell voltage increases to a certain extent; however, the charge/discharge current decreases substantially and the cell temperature also decreases to a certain extent. The system load power decreases substantially and the continuous discharge rating becomes 75 W or less.

Then, as mentioned above, if the system load power exceeds the continuous discharge rating (75 W), power control is transferred to the protective zone, where the frequency cap is lowered by approximately 80%, and the system load power decreases substantially.

If there is a predetermined difference between the adapter rating of the computer (180 W) and the continuous discharge rating of the battery (75 W), the throttle control of the present embodiment can prevent the battery pack from overheating and, consequently, malfunctioning while maintaining the performance of the CPU as much as possible.

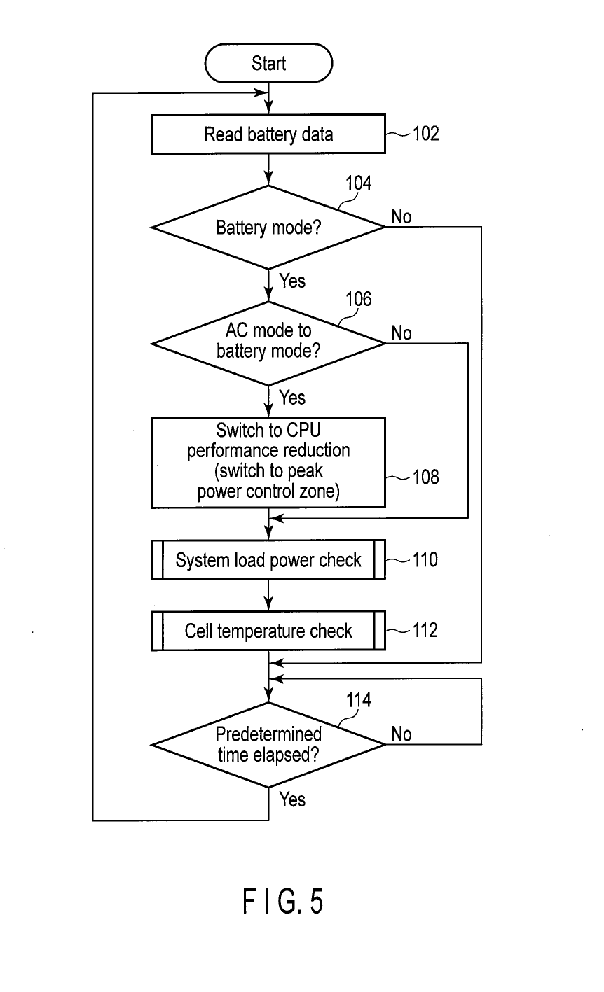

FIG. 5 is a flowchart showing the function of the embedded controller 28.

The battery data (including charge/discharge current, charge/discharge voltage, capacity, cell temperature, cell voltage, and internal status, etc.) is read from the EEPROM 42 of the battery pack 48 at predetermined time intervals (block 102). The internal status indicates in what zone in FIG. 2 the power control is performed. As shown in FIG. 2, the condition (threshold) used to decide the transfer of power control varies based on the zone in FIG. 2 in which the power control is performed.

Whether or not the battery mode is on is determined in block 104. If it is not, the embedded controller 28 stops its function and waits until the next reading time comes.

When the battery mode is on, whether or not the AC mode was on at the previous reading time is determined in block 116. That is, whether or not the drive mode is switched from the AC adapter driven-mode to the battery mode is determined.

When the drive mode is switched from the AC mode to the battery mode, the system load power may possibly exceed the peak threshold, and to perform throttle control to a certain extent, the power control of the computer is transferred to the peak zone in block 108. Thus, the clock frequency of the CPU is decreased by approximately 30%, and the system load power is reduced, too. If the battery mode was on at the previous reading time, block 108 is skipped. The transfer of the power control (throttle control) of the computer in block 108 is reported by the embedded controller 28 to the BIOS and by the BIOS to the OS 16a.

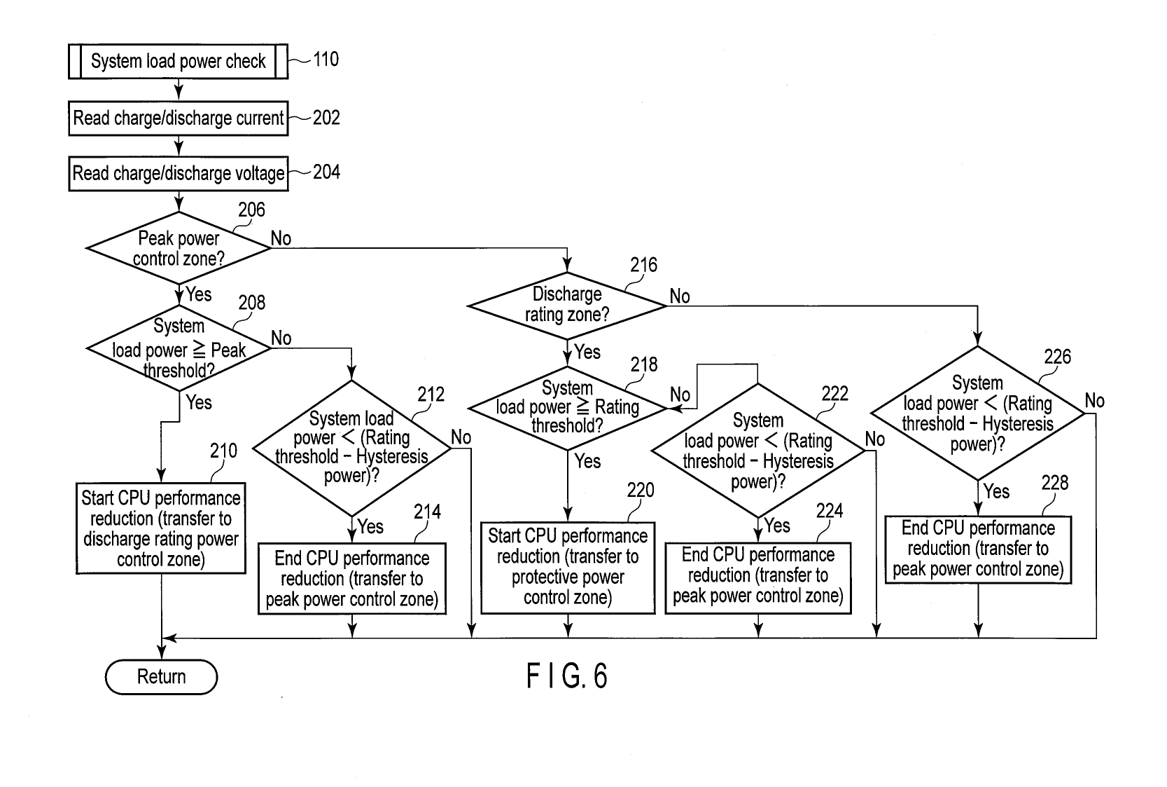

A system load power check is performed in block 110. FIG. 6 illustrates details of the system load power check. Here, the battery pack 48 discharges (supplies power) according to the system load power, the discharge power and the system load power are equivalent.

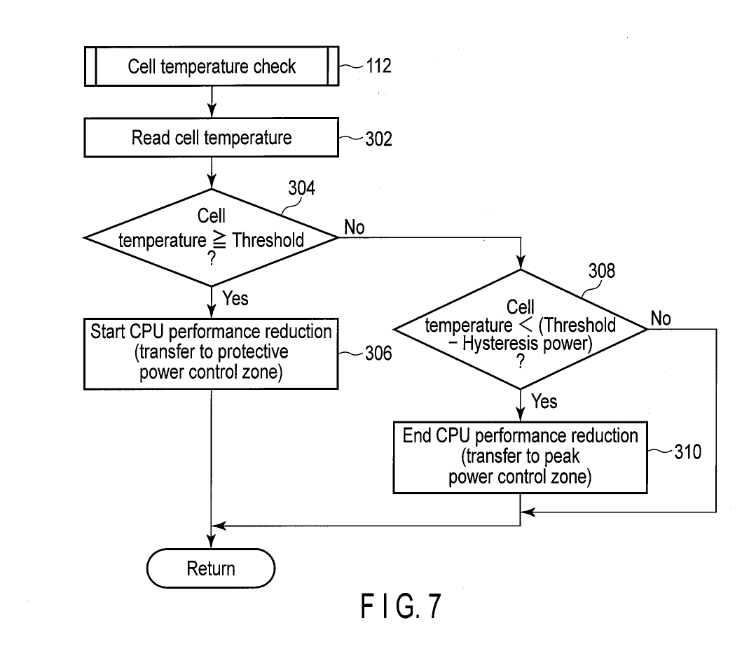

A cell temperature check is performed in block 112. FIG. 7 illustrates details of the cell temperature check.

Whether or not a predetermined period of time has passed after reading the data in block 102 is determined in block 114. The embedded controller 28 stands by in block 114 until the predetermined period of time passes. After the predetermined period of time passes, the embedded controller 28 returns to block 102 to read the battery data again.

FIG. 6 is a flowchart indicating the details of the system load power check 110 in FIG. 5.

The charge/discharge current is read from the battery pack 48 in block 202. The charge/discharge voltage is read from the battery pack 48 in block 204.

Whether or not the power control of the computer is in the peak zone is determined in block 206. This determination is performed based on the internal status included in the battery data read in block 102 (in FIG. 5). As is obvious from block 108 of FIG. 5, the power control is still in the peak zone immediately after the AC adapter is detached, the determination yields YES (control is in the peak zone).

If the determination in block 206 yields YES, then whether or not the system load power (referred to as “system power” in FIG. 6) is greater than or equal to the peak threshold (90 W) is determined in block 208. The system load power can be derived from the charge/discharge current read in block 202 and from the charge/discharge voltage read in block 204.

If the determination in block 208 yields YES, the system load power must be reduced. Thus, the power control of the computer is transferred to the discharge rating zone in block 210 to perform throttle control to further lower the clock frequency. Thus, the clock frequency of the CPU is decreased by approximately 30% and the system load power is decreased accordingly. Then, the execution proceeds to the cell temperature check block 112 in FIG. 5.

If the determination in block 208 yields NO, then whether or not the system load power is less than [Rating threshold (continuous discharge rating: 75 W)−Hysteresis power (10 W, for example)] is determined in block 212. If the determination in block 212 yields YES, it means that the system load power has already been reduced substantially, and thus, the system load power can be increased. Therefore, the power control of the computer is transferred to the peak zone in block 214 to perform throttle control with the raised clock frequency (this transfer is referred to as “ending CPU performance reduction”). As a result, the decrease of the clock frequency of the CPU is suppressed up to approximately 30%, and the system load power is increased. Then, the execution proceeds to the cell temperature check 112. If the determination in block 212 yields NO, the execution immediately proceeds to the cell temperature check block 112 in FIG. 5.

If the determination in block 206 yields NO, then whether or not the power control of the computer is in the discharge rating zone is determined in block 216. If it is in the discharge rating zone, whether or not the system load power is greater than or equal to the rating threshold (continuous discharge rating: 75 W) is determined in block 218.

If the determination in block 218 yields YES, the system load power must be reduced. Thus, the power control of the computer is transferred to the protective zone in block 220 to perform throttle control to further lower the clock frequency. Thus, the clock frequency of the CPU is decreased by approximately 80% and the system load power is decreased accordingly. Then, execution proceeds to the cell temperature check block 112 in FIG. 5.

If the determination in block 218 yields NO, then whether or not the system load power is less than [Rating threshold (continuous discharge rating: 75 W)−Hysteresis power (10 W, for example)] is determined in block 222. If the determination in block 222 yields YES, it means that the system load power has already been reduced substantially, and thus, the system load power can be increased. Therefore, the power control of the computer is transferred to the peak zone in block 224 to perform throttle control with the raised clock frequency (ending CPU performance reduction). As a result, the decrease of the clock frequency of the CPU is suppressed up to approximately 30%, and the system load power is increased. Then, the execution proceeds to the cell temperature check block 112. If the determination in block 222 yields NO, the execution immediately proceeds to the cell temperature check block 112 in FIG. 5.

If the determination in block 216 yields NO, that is, if the power control of the computer is in the protective control zone, then whether or not the system load power is less than [Rating threshold (continuous discharge rating: 75 W)−Hysteresis power (10 W, for example)] is determined in block 226. If the determination in block 226 yields YES, it means that the system load power has already been reduced substantially, and thus, the system load power can be increased. Therefore, the power control of the computer is transferred to the peak zone in block 228 to perform throttle control with a raised clock frequency (end CPU performance reduction). As a result, the decrease of the clock frequency of the CPU is suppressed up to approximately 30%, and the system load power is increased. Then, the execution proceeds to the cell temperature check block 112. If the determination in block 226 yields NO, the execution immediately proceeds to the cell temperature check block 112 in FIG. 5.

The transfer of the power control (throttle control) of the computer at each of blocks 210, 214, 220, 224, and 228 is, as in the case of block 108, reported by the embedded controller 28 to the BIOS and by the BIOS to the OS 16a.

As described, the hysteresis (10 W, for example) is given to the threshold of the system load power to correspond both cases where the power control zone of the computer is transferred to decrease the performance of the CPU and where it is transferred to increase the performance of the CPU. Therefore, the power control zone is prevented from changing frequently because of an error. Note that the hysteresis is added to the threshold for ending the CPU performance reduction in the example of FIG. 6; however, the addition of the hysteresis is not limited to such a use only and the hysteresis may be added to the threshold for starting the CPU performance reduction.

FIG. 7 is a flowchart indicating the details of the cell temperature check block 112 shown in FIG. 5.

The cell temperature is read from the battery pack 48 in block 302.

Whether or not the cell temperature is greater than or equal to the threshold (70° C., for example) is determined in block 304. The threshold is set to 70° C. here to allow a margin with respect to the upper limit of the cell temperature which is, as mentioned above, 80° C.

If the determination in block 304 yields YES, the system load power must be reduced. Thus, the power control of the computer is transferred to the protective zone in block 306 to perform throttle control to further lower the clock frequency. A higher priority is given to the cell temperature control than the continuous discharge rating, and thus, if the cell temperature is greater than or equal to the threshold, the power control is transferred to the protective zone, whose power reduction effect is the highest of the three zones, even if the system load power can still manage the discharge. Therefore, the clock frequency of the CPU is decreased by approximately 80%, the system load power is decreased accordingly, and the performance of the CPU is set to low.

If the determination in block 304 yields NO, then whether or not the cell temperature is less than [Threshold−Hysteresis temperature (5° C., for example)] is determined in block 308. If the determination in block 308 yields YES, it means that the system load power has already been reduced substantially, and thus, the system load power can be increased. Therefore, the power control of the computer is transferred to the peak zone in block 310 to perform throttle control with a raised clock frequency (end CPU performance reduction). As a result, the decrease of the clock frequency of the CPU is suppressed up to approximately 30%, and the system load power is increased.

As described above, according to the first embodiment, the system load power is reduced by watching the system load power and the cell temperature and reducing the performance of the CPU at predetermined intervals during the battery mode so that the battery can perform the discharge. Furthermore, in addition to the continuous discharge rating, the peak threshold (which is greater than the continuous discharge rating) is defined and the power control zone is divided into the three zones. Consequently, the secondary battery can be used safely without reducing the performance of the CPU substantially even if the system load power exceeds the continuous discharge rating.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus driven by a secondary battery, comprising:
a measurement module configured to measure power of the secondary battery;
a comparator configured to compare the power measured by the measurement module with a first threshold and with a second threshold smaller than the first threshold; and
a controller configured to, when the electronic apparatus is driven by the secondary battery, operate the electronic apparatus in any one of a first power range, second power range, and third power range based on the comparison by the comparator, wherein
the first power range requires greater power than power required in the second power range, and
the second power range requires greater power than power required in the third power range.

2. The electronic apparatus of claim 1, wherein
the controller is configured to operate the electronic apparatus in the first power range when the power measured by the measurement module is larger than or equal to the first threshold while the electronic apparatus is operated in the second power range, and
the controller is configured to operate the electronic apparatus in the second power range when the power measured by the measurement module is smaller than the first threshold while the electronic apparatus is operated in the first power range.

3. The electronic apparatus of claim 2, wherein the controller is configured to operate the electronic apparatus in the second power range when the power measured by the measurement module is smaller than the first threshold minus a predetermined value while the electronic apparatus is operated in the first power range.

4. The electronic apparatus of claim 2, wherein
the controller is configured to operate the electronic apparatus in the second power range when the power measured by the measurement module is larger than or equal to the second threshold while the electronic apparatus is operated in the third power range, and
the controller is configured to operate the electronic apparatus in the third power range when the power measured by the measurement module is smaller than the second threshold while the electronic apparatus is operated in the second power range.

5. The electronic apparatus of claim 4, wherein the controller is configured to operate the electronic apparatus in the third power range when the power measured by the measurement module is smaller than the second threshold minus a predetermined value while the electronic apparatus is operated within the second power range.

6. The electronic apparatus of claim 1, wherein the controller is configured to operate the electronic apparatus in the first power range when a drive mode of the electronic apparatus is switched to a secondary-battery power supply mode from an AC power supply mode.

7. The electronic apparatus of claim 1, wherein the second threshold is an upper limit of continuously dischargeable power supplied from the secondary battery, and the first threshold is an upper limit of power supplied from the secondary battery in which the temperature of the secondary battery does not exceed an upper limit temperature.

8. The electronic apparatus of claim 1, further comprising a temperature sensor configured to sense the temperature of the secondary battery, wherein the controller is configured to operate the electronic apparatus in the third power range when the temperature of the secondary battery is larger than or equal to a threshold temperature.

9. The electronic apparatus of claim 1, further comprising a processor,
wherein the controller is configured to vary a clock frequency of the processor or a driving voltage of the processor based on the comparison by the comparison module.

10. A method comprising:
measuring power of a secondary battery of an electronic apparatus;
comparing the measured power with a first threshold and with a second threshold smaller than the first threshold; and
operating, when the electronic apparatus is driven by the secondary battery, the electronic apparatus in any one of a first power range, second power range, and third power range based on the comparison, wherein
the first power range requires greater power than power required in the second power range, and
the second power range requires greater power than power required in the third power range.

11. The method of claim 10, wherein
the electronic apparatus is operated in the first power range when the measured power is larger than or equal to the first threshold while the electronic apparatus is operated in the second power range, and
the electronic apparatus is operated in the second power range when the measured power is smaller than the first threshold while the electronic apparatus is operated in the first power range.

12. The method of claim 10, wherein the electronic apparatus is operated in the first power range when a drive mode of the electronic apparatus is switched to a secondary-battery power supply mode from an AC power supply mode.

13. The method of claim 10, further comprising sensing the temperature of the secondary battery, wherein the electronic apparatus is operated in the third power range when the temperature of the secondary battery is larger than or equal to a threshold temperature.

14. A non-transitory computer-readable storage medium storing computer-executable instructions that, when executed, cause a computer to:
measure power of a secondary battery of an electronic apparatus;
compare the measured power with a first threshold and with a second threshold smaller than the first threshold; and
operate, when the electronic apparatus is driven by the secondary battery, the electronic apparatus in any one of a first power range, second power range, and third power range based on the comparison, wherein
the first power range requires greater power than power required in the second power range, and
the second power range requires greater power than power required in the third power range.

15. The storage medium of claim 14, wherein
the electronic apparatus is operated in the first power range when the measured power is larger than or equal to the first threshold while the electronic apparatus is operated in the second power range, and
the electronic apparatus is operated in the second power range when the measured power is smaller than the first threshold while the electronic apparatus is operated in the first power range.

16. The storage medium of claim 14, wherein the electronic apparatus is operated in the first power range when a drive mode of the electronic apparatus is switched to a secondary-battery power supply mode from an AC power supply mode.

17. The storage medium of claim 14, wherein the temperature of the secondary battery is sensed, wherein the electronic apparatus is operated in the third power range when the temperature of the secondary battery is larger than or equal to a threshold temperature.
